(19) United States
(12) Patent Application Publication
(10) Pub. No.: US 2022/0275638 A1
(43) Pub. Date: Sep. 1, 2022

(54) FREE STANDING ONE-PIECE SPACE DIVIDER

(71) Applicant: USG Ceilings Plus, LLC, Commerce, CA (US)

(72) Inventors: Stephen Hettwer, Chino Hills, CA (US); Mark Joseph, Chicago, IL (US)

(21) Appl. No.: 17/186,660

(22) Filed: Feb. 26, 2021

(51) Int. Cl. E04B 2/74; E05D 1/02

(52) U.S. Cl. CPC E04B 2/7429; E05D 1/02; E05Y 2900/142

(57) ABSTRACT

A space divider made from a single board having a fibrous composition, the board being severed to define a plurality of elongated panels separated along lines at edges of the panels and being machined to form hinge structure along said lines, the hinge structure being formed by machining to remove stock from the board while leaving living hinge elements of said fibrous composition at said hinge structure, the hinge structure being constructed and arranged to enable associated panels to be folded against one another.

### BACKGROUND OF THE INVENTION

The invention relates to a multi-panel screen or room divider.

### PRIOR ART

Room dividers having hinged panels have long been known, some of them having acoustical absorption properties and most of them being partially or completely opaque. Typically, a room or space divider has three elongated panels, say 5 foot tall, and collectively extending to 5 or 6 feet wide. Frequently, the panels are joined with metal hinges with barrels and pins outside the perimeter of the panels and screwed or otherwise fixed on the long edges of adjacent panels.

It is desirable that separate hinges be avoided to reduce material and labor costs or expensive automatic assembly equipment. Regular hinges, sticking out past the panel edges can snag and/or scratch room or furniture surfaces when the divider is folded and moved. Aesthetically, separate hinges distract from the appearance of a divider.

### SUMMARY OF THE INVENTION

The invention provides a foldable one-piece multi-panel space divider or screen in which the hinges between panels are integral with the panels themselves. Preferably, the divider is fabricated from rigid, fibrous, porous board stock. For instance, the board stock is commercially available felt like needled PET fiber such as disclosed in U.S. Pat. No. 7,641,962, that is homogenous from major face to major face. This material exhibits high NRC values due to its porosity. This preferred material is also light in weight making it easy to carry and handle and relatively inexpensive to ship.

As disclosed, the original board stock is large enough to span the height and length of the desired divider or screen. The board stock is locally machined into a number of panels attached to each other with integral hinges also machined into the board stock. Preferably, the hinges are of a construction that enables an associated pair of panels to be hinged or folded 360 degrees in either direction. Ideally, multiple hinges are spaced along the vertical edges of adjacent panels so that their collective length is a small fraction of the length of a panel, i.e. the height of the screen, so that the resistance of the hinges to the panels being opened or closed due to memory in the hinges is small or negligible thereby facilitating set-up or take-down of the screen.

The low density of the material forming the panels and absence of a frame results in a low weight screen which is easily carried and manipulated.

### BRIEF DESCRIPTION OF THE DRAWINGS

FIG. 1 is an isometric view of the space divider of the invention in an open standing position;

FIG. 2 is an enlarged fragmentary view of an open hinge of the divider;

FIG. 3 is an enlarged horizontal cross-section of a typical hinge;

FIG. 4 is an isometric view of the divider in a closed condition for storage;

FIG. 5 is an enlarged fragmentary isometric view of a typical hinge in a closed position; and

FIG. 6 is an enlarged fragmentary cross-sectional view of a typical hinge in a closed position.

### DESCRIPTION OF THE PREFERRED EMBODIMENTS

An acoustical room or space divider 10 is shown having, for example, three elongated panels 11 hinged together at adjacent long edges. By way of example, each panel can be about 2 feet (609.6 mm) wide, 5⅓ feet (1625.6 mm) long, and ½ inch (12 mm) thick. Each panel 11 is made from commercially available porous, opaque boards made of needled polyethylene terephthalate (PET) fibers. Such boards, in ½ thickness are rigid, and shelf-supporting and exhibit excellent noise absorption with an NRC rating of about 0.7 to about 0.8 with a ½ inch (12 mm) thickness. Other suitable rigid fibrous boards are known, for example, in the suspended ceiling art.

The divider or screen 10 including the panels 11 and hinges 12 between the panels are all made from a single board such that these elements are all integral with one another. A cutter or cutters manipulated with NC control, machines the original single board, to remove stock and fashion the compound hinges 12, described in more detail below, and separate the panels 11 with slots 15 on vertical lines between the hinges, above a top hinge and below a bottom hinge.

FIG. 3 illustrates a horizontal cross-section of a compound hinge 12, all of the hinges preferably being identical.

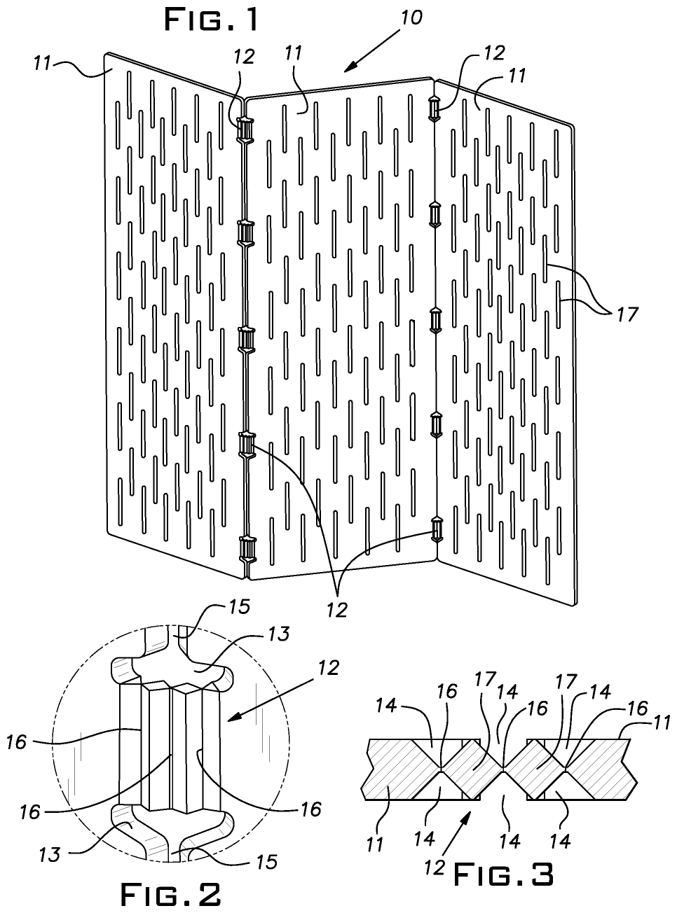

FIG. 2 shows clearance slots 13 in adjacent panels 11 at the top and bottom of a compound hinge 12. A cutter or cutters machining a compound hinge 12 makes three 90 degree V-shaped slots 14 on each face of the board. The slots 14 on one face being in alignment with the slots on the other face, leaving three living hinges 16 making up one of the compound hinges 12 where the fibrous material of the original board remains in place maintaining adjacent panels 11 interconnected and forming two blocks 17 of essentially square cross-section. Each block 17 is associated with an outlying and a central living hinge 16. By way of example, but not limitation, the blocks 17 and therefore the hinges can be 2 inches long.

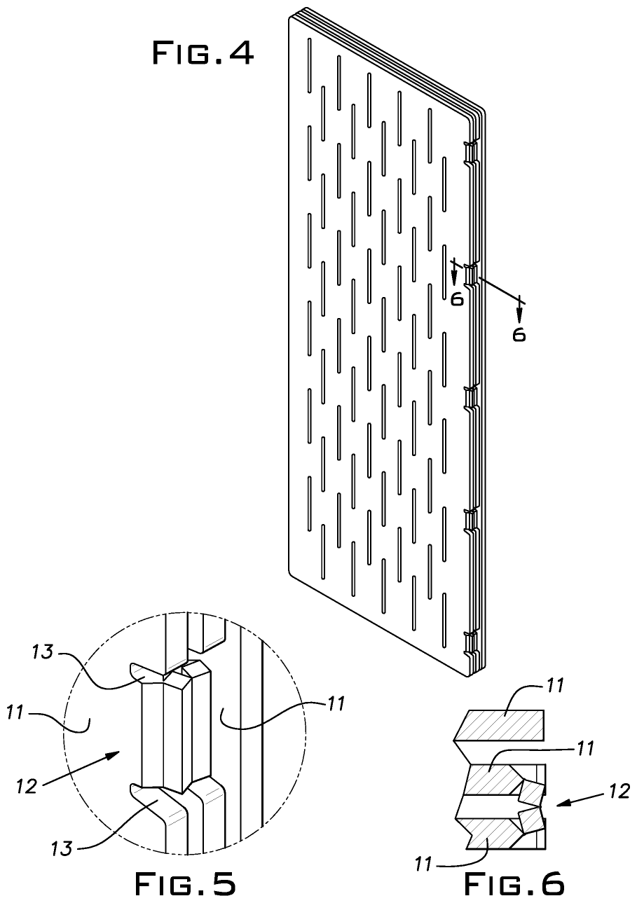

As suggested in FIGS. 3 and 6, the compound hinges 12 each having 3 living hinges 16 and two intervening blocks 17 enable associated, adjacent panels 11 to be folded 360 degrees in either direction. This feature permits the divider to be folded flat for storage. In the folded flat position, as shown in FIGS. 4, 5 and 6, all of the elements of a compound hinge 12 are inside the perimeter of the panels 11, thereby being protected from snagging other objects when being moved by the user and simplifying packaging for the manufacturer.

The collective length of the 5 compound hinges 12, in the illustrated example each with 2 inch length, is 10 inches and is less than ⅙ of the height of the divider 10; it is envisioned that the collective hinge length could be increased to as much as about ⅓ the height of the divider. By limiting the collective length of the hinges, the stiffness and/or memory of the living compound hinges 12 is limited to make erection or take-down of the divider 10 relatively easy.

The multitude of narrow rectangular patterns 17 on the panels 11 are for exemplary decorative purposes and may represent painted images or additional material adhered to the faces of the panels.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A space divider made from a single board having a fibrous composition, the board being severed to define a plurality of elongated panels separated along lines at edges of the panels and being machined to form hinge structure along said lines, the hinge structure being formed by machining to remove stock from the board while leaving living hinge elements of said fibrous composition at said hinge structure, the hinge structure being constructed and arranged to enable associated panels to be folded against one another.

2. A space divider as set forth in claim 1, wherein said hinge structure is constructed and arranged to permit one of its associated panels to be folded 360 degrees relative to an adjacent associated panel.

3. A space divider as set forth in claim 1, wherein said hinge structure is at multiple spaced locations along adjacent edges of the panels.

4. A space divider as set forth in claim 1, wherein the collective length of the spaced hinge structures is a small fraction of the length of a panel.

5. A space divider as set forth in claim 1, wherein the hinge structure comprises three living hinges.

6. A space divider as set forth in claim 5, wherein the hinge structure comprises two machined blocks of the board composition each situated between two of said living hinges.

7. A space divider made from a single board having a generally uniform fibrous composition, the board being machined to remove stock to form a plurality of mostly separate panels and a plurality of compound hinges between the panels, the compound hinges comprising spacing elements of said fibrous composition and living hinges of said fibrous composition on opposite parts of said spacing elements, said compound hinges being constructed and arranged to enable adjacent panels to be folded 360 degrees relative to each other.
